(19) United States
(12) Patent Application Publication
(10) Pub. No.: US 2002/0191796 A1
(43) Pub. Date: Dec. 19, 2002

(54) Symmetric and asymmetric encryption method with arbitrarily selectable one-time keys

(76) Inventor: Hans-Joachim Muschenborn, Walchwil (CH)

Correspondence Address: DR. HANS-GOACHIM MUSCHENBORN, BUNDESSTR. 7, CH-6304 ZUG, SWITZERLAND, CH-6304, CH

(21) Appl. No.: 10/161,723

(22) Filed: Jun. 5, 2002

(30) Foreign Application Priority Data
Jun. 18, 2001 (DE) 101 29 285

(51) Int. Cl. H04L 9/00

(52) U.S. Cl. 380/277

(57) ABSTRACT

The present invention concerns symmetric and asymmetric encryption key management methods and sets of encryption methods to encrypt and decrypt arbitrary data, which can be divided into n (n>=2) data blocks D₀, . . . , Dₙ₋₁, continuous data streams of known or unknown length or sequences of a known or unknown number of messages between at least two communication partners using variable—in particular arbitrarily selectable and/or randomized one-time—encryption keys.

The current invention overcomes prior art by encrypting arbitrary data, which can be divided into a given number of n data blocks, a continuous data stream of unknown length, a sequence of a known or unknown number of messages between at least two communication partners, using encryption methods to encrypt each individual data block with an arbitrarily selectable encryption algorithm and a new encryption key resulting from an arbitrarily selectable encryption key generator in dependence of a basic encryption key and arbitrarily—i.e. pseudo or absolutely randomly—selectable partial keys, where each encrypted data block EDᵢ contains the original data Dᵢ and a new partial key PKᵢ₊₁ for the next data block EDᵢ₊₁. By choice of particular encryption algorithms and encryption key generators perfect backward and forward security can be obtained, such that an attacker must know the complete encryption history to decrypt past and future encrypted data.

### CROSS-REFERENCES TO RELATED APPLICATIONS

This invention can be used in any information processing system according to the following related patent applications:

1. U.S. utility patent application Ser. No. 09/558,435 filed on Apr. 25, 2000 and

2. U.S. utility patent application Ser. No. 09/740,925 filed on Dec. 19, 2000.

### STATEMENT REGARDING FEDERALLY SPONSORED RESEARCH AND DEVELOPMENT

Not Applicable

### REFERENCES TO OTHER PATENTS

U.S. Pat Nos. 4,200,770, 4,405,829, 5,003,597, PCT/NL94/00245, U.S. Pat. Nos. 5,799,089, 5,870,470, 5,974,144, 5,987,124, 5,425,103, 5,488,661, 5,619,576, 5,621,799, 5,703,948, DE 3,244,537

### REFERENCES TO ADDITIONAL MATERIAL

RFC 2409 “IPSec”, 2000, Addison Wesley, p. 117ff, and p. 142 Habutsu, “Secret key cryptosystem by iterating a chaotic map” in Lecture notes in computer Science, V 0547, Springer, 1991

1. Technical Field

The present invention concerns symmetric and asymmetric encryption key management methods and sets of encryption methods to encrypt and decrypt arbitrary data, which can be divided into n (n>=2) data blocks D₀, . . . , Dₙ₋₁, continuous data streams of known or unknown length or sequences of a known or unknown number of messages between at least two communication partners using variable—in particular arbitrarily selectable and/or randomized one-time—encryption keys.

2. Background of the Invention

Prior art encryption methods use secret keys either directly as encryption keys or derive the encryption keys from one or more secret keys. All secret keys have to be known by all communication partners, who want to decrypt the encrypted data in order to gain access to the original data. An attacker, who discovered such a secret key, has the possibility to derive himself all encryption keys derived from the uncovered secret key and to decrypt past and future encrypted communication. Such a system neither offers perfect backward nor perfect forward security.

Perfect back- and forward security can be obtained through regular exchange of the shared secret key(s) by (a) new secret key(s), which are completely independent from the previous secret key(s). An attacker, who reveals in such a case a single secret key, can only decrypt the part of the encrypted data, which was or will be encrypted with the uncovered secret key.

In case of the Internet Key Exchange (IKE) protocol according to RFC 2409 (see also “IPSec”, 2000, Addison Wesley, p. 117ff, and p. 142) a limited or perfect forward security can be achieved by regular exchanges of the secret key between the parties—i.e. according to Diffie-Hellmann (U.S. Pat. No. 4,200,770) or RSA (U.S. Pat. No. 4,405,829)—, where the data or message stream is encrypted with the latest exchanged secret key.

To guarantee perfect forward security per individual data block, each data block needs to be encrypted with a completely independent new secret key. The resulting frequent key exchanges before each individual data block consume a very high amount of system resources (CPU-time and communication bandwidth). Using IKE/IPSec perfect forward security reduces the effective communication bandwidth so much, that it is seldom used on the level of individual data blocks. Instead key exchanges are normally applied only after the transmission of a larger number of data blocks encrypted with the same key. In practice, IKE/IPSec systems guarantee only limited backward and forward security.

Various other block oriented encryption methods according to U.S. Pat. No. 5,003,597, PCT/NL94/00245 and U.S. Pat. Nos. 5,799,089, 5,870,470, 5,974,144, 5,987,124 and encryption methods using variable encryption keys according to U.S. Pat. Nos. 5,425,103, 5,488,661, 5,619,576, 5,621,799, 5,703,948 und DE 3244537, as well as T. Habatsu, “Secret key cryptosystem by iterating a chaotic map”, Lecture notes in Computer Science, Vol. 547, Springer, 1991 are known.

None of the prior art encryption methods is capable to encrypt each data block with a new encryption key, which can be derived from a single secret basic encrpytion key and absolutely independent and arbitrarily selectable partial keys, where each encrypted data block EDᵢ contains both the original data Dᵢ and the partial key PKᵢ₊₁ for the following encrypted data block EDᵢ₊₁.

### OBJECT OF THIS INVENTION

The object of this invention is to encrypt and decrypt arbitrary data, which can be divided in a known number n of data blocks, a continuous data stream of unknown length, a sequence of a known number of n messages exchanged between at least two communication partners, or a sequence of an undetermined number of messages exchanged between at least two communication partners with perfect back- and forward security by variable—in particular arbitrarily selectable and/or randomized one-time—encryption keys and minimal resource consumption.

### SUMMARY OF THIS INVENTION

The present invention overcomes the prior art limitations by iterative symmetric or asymmetric encryption and decryption methods using a single secret basic encryption key BEK and arbitrarily selectable partial keys PKᵢ to generate virtually independent one-time encryption keys EKᵢ for each iteration. The original data/message or data/message stream is divided into a known or unknown number of data blocks Dᵢ of arbitrary size, each data block Dᵢ is merged together with a new arbitrarily selectable partial key PKᵢ₊₁ for the next data block Dᵢ₊₁, encrypted using encryption algorithm EAᵢ with encryption key EKᵢ and decrypted using decryption algorithm DAᵢ and decryption key DKᵢ derived from a basic decryption key BDK corresponding to said basic encryption key BEK. Starting with EK₀=BEK all following encryption keys EKᵢ₊₁ (i>0) are generated by encryption key generator EKGᵢ₊₁ in dependence of all or any part of the previously transmitted information, in particular the basic encryption key BEK, the basic decryption key BDK and the partial keys PK₁, . . . , PKᵢ. The encryption/decryption algorithm pairs EAᵢ/DAᵢ as well as the encryption/decryption key generator pairs EKGᵢ/DKGᵢ can be chosen arbitrarily and varied from iteration to iteration in dependence of all previously exchanged information.

### BRIEF DESCRIPTION OF FIGURES

FIG. 1: illustrates the sequences of steps performed in the i^{th} iteration by a) the encryptor and b) the decryptor using an encryption method according to claims 1 or 2.

FIG. 2: illustrates the sequences of steps performed in the i^{th} iteration in a typical sender/receiver setup by a) the sender and encryptor P₁ and b) the recipient and decryptor P₂ using an encryption method according to claims 3 or 4.

FIG. 3: illustrates an example of an encryption method according to claims 3 or 4 using different basic encryption and decryption keys and different encryption and decryption key generators (i.e. an asymmetric encryption method).

FIG. 4: illustrates another example of an encryption method according to claims 3 or 4, where for each i>=0 the encryption key EKᵢ is identical to the decryption key DKᵢ (i.e. a symmetric encryption method). In contrast to the example given in FIG. 2 in this example P₁ and P₂ alternate in iteration k and k+1 as sender resp. receiver.

### DETAILED DESCRIPTION OF THIS INVENTION

The present invention overcomes the prior art limitations by symmetric or asymmetric iterative encryption methods using arbitrarily selectable one-time keys according to claims 1 to 4 by dividing the original data resp. data stream into data blocks of arbitrary size, whereby each data block or message in a sequence is merged and encrypted together with an arbitrarily selectable partial key for the next data block resp. message. The applied encryption algorithms EAᵢ and encryption key generators EKGᵢ can arbitrarily be chosen for each individual iteration, as long as the decryptor either knows the decryption algorithm DAᵢ corresponding to encryption algorithm EAᵢ and the decryption key generator DKGᵢ corresponding to encryption key generator EKGᵢ in advance or is able to determine them from all previously transmitted data.

The methods described in the present patent can be applied to

1. arbitrary data D, which data D can be divided into n (n>=2) data blocks D₀, . . . , Dₙ₋₁, where each data block Dᵢ is of arbitrary size (claim 1),

2. a continuous data stream DS of unknown length, which data stream DS can be divided into a sequence of an unknown number of data blocks Dᵢ (i>0), where each data block Dᵢ is of arbitrary size (claim 2),

3. a sequence of n messages Mᵢ (0<=i<n), where each message Mᵢ is of arbitrary size, between an arbitrary number p>=2 of communication partners P₁, . . . , Pₚ (claim 3),

4. a sequence of an unknown number of messages Mᵢ (0<=i), where each message Mᵢ is of arbitrary size, between an arbitrary number p>=2 of communication partners P₁, . . . , Pₚ (claim 4).

In methods according to claims 1 and 3, which suppose a known number n of data blocks resp. messages, it is obviously not necessary for the encryptor to calculate in the last iteration the following encryption key EKₙ and for the decryptor to calculate in the last iteration the following decryption key DKₙ (claim 5).

Encryption methods according to claims 1 to 5 suppose, that the basic encryption key BEK is previously known to the encryptor and that the decryptor knows at least one basic decryption key BDK corresponding to basic encryption key BEK. The way how both parties gain resp. demonstrate to each other knowledge of the basic encryption key BEK resp. basic descryption key BDK can be implemented for example according to state of the art key exchange methods (claim 6) or state of the art knowledge proofs (claims 7 and 9), where it is particular advantageous to use knowledge proofs, which do not require to exchange the secret basic keys explicitly (claims 8 and 10) between sender and receiver. The choice of partial keys PKᵢ by the encryptor is absolutely arbitrary and can be performed using a pseudo random number generator (claim 11) or an absolute random number generator (claim 12). A perfect absolute random number generator is for example any kind of physical measurement, like a measurement of the noise in a noisy personal computer audio card.

Claims 1 to 12 cover also the special cases, that

1. the basic encryption key BEK is identical to the basic decryption key BDK,

2. for each i>=0 the encryption key generator EKGᵢ is identical to the decryption key generator DKGᵢ and therefore for each i>=0 the encryption key EKᵢ is identical to the decryption key DKᵢ (symmetric encryption/decryption methods),

3. the same encryption/decryption algorithms are used at least for two—in particular also for all—iterations (claim 15), or

4. the encryption algorithm EAᵢ is chosen out of a set SEAᵢ of different known encryption algorithms in dependence of any previously used encryption keys EK₀, . . . , EKᵢ and/or previously transmitted data D₀, . . . , D_{i 1}, partial keys PK₁, . . . , PKᵢ or encrypted data EDᵢ resp. encrypted message EMᵢ, such that the decryptor can determine the decryption algorithm DAᵢ corresponding to encryption algorithm EAᵢ in dependence of all previously used decryption keys DK₀, . . . , DKᵢ and/or previously transmitted data D₀, . . . , Dᵢ₋₁, partial keys PK₁, . . . , PKᵢ or encrypted data EDᵢ resp. encrypted message EMᵢ (claim 16), out of a set SDAᵢ of different decryption algorithms corresponding to the set SEAᵢ of encryption algorithms, where the set of encryption alogorithms SEAᵢ can be identical for all or any subset of iterations (claim 17) or be unique for each iteration.

Claims 18 to 20 cover special cases for the choice of encryption key generators EKGᵢ. Claims 21 to 23 describe an extension of the original data block or message by additional pseudo or absolute random data to harden the system further against statistical attacks.

The absolute arbitrary choice of partial keys PKᵢ and the determination of the final encryption keys EKᵢ₊₁ resp. decryption keys DKᵢ₊₁ in dependence of all previous data known to the encryptor resp. the decryptor—in particular the basic encryption key BEK resp. basic decryption key BDK and all previously transmitted partial keys—prohibits an attacker, with the knowledge acquired through the decryption of a single data block/message alone, from decrypting any previous or future encrypted data block/message. If the partial keys are generated from or chosen to be either pseudo or absolute random numbers and the encryption resp. decryption key generator(s) is(are) (a) strong one-way hash function(s), it is impossible to condense one of the basic keys by—currently favored and often very successful—statistical attacks, since the statistical distribution of the final encryption keys EKᵢ resp. decryption keys DKᵢ converges with increasing number of contributing random partial keys PKᵢ to a uniform distribution and therefore contains a decreasing amount of extractable information.

The partial keys PKᵢ₊₁ are merged, encrypted and transmitted together with the original data or messages D/Mᵢ, so that the encryption methods described in claims 1 to 23 of this patent guarantee perfect forward and backward security without having to exchange more than a single secret key.

Compared to prior art encryption methods using a single secret encryption key, the encryption methods presented in this patent increase the overall data volume only by the additional partial keys and the effort to generate a new encryption/decryption key for each data block/message.

At the same time the random partial keys, merged and encrypted with the original data, protect as so-called “salt”—i.e. additional merged random data to generate different encrypted data for each encryption process even using the same original data, keys and encryption algorithms—the encrypted messages further. This feature can be achieved in prior art methods only by merging additional random data. In prior art methods this additional “salt” increases the data volume without any other functionality.

The double function of the additional “salt” used in encryption methods according to claims 1 to 23 of this patent, i.e. first to randomize the encrypted data and second to serve at the same time to determine the final encryption keys, is one of their special advantages compared to prior art encryption methods.

Compared to U.S. Pat. No. 5,870,470 and 5,987,124 an encryption method according to claims 1 to 4 concerns predominately the key management rather than specific encryption algorithms. In particular the masking of the original data is NOT required in an encryption method according to claims 1 to 4. In addition, neither U.S. Pat. No. 5,870,470 nor 5,987,124 describe methods with arbitrarily selectable one-time keys, so that the usage of a single-static-encryption key has to be assumed. Nevertheless, an encryption method according to U.S. Pat. No. 5,870,470 or 5,987,124 can be used as encryption algorithm EAᵢ in an encryption method according to claims 1 to 4.

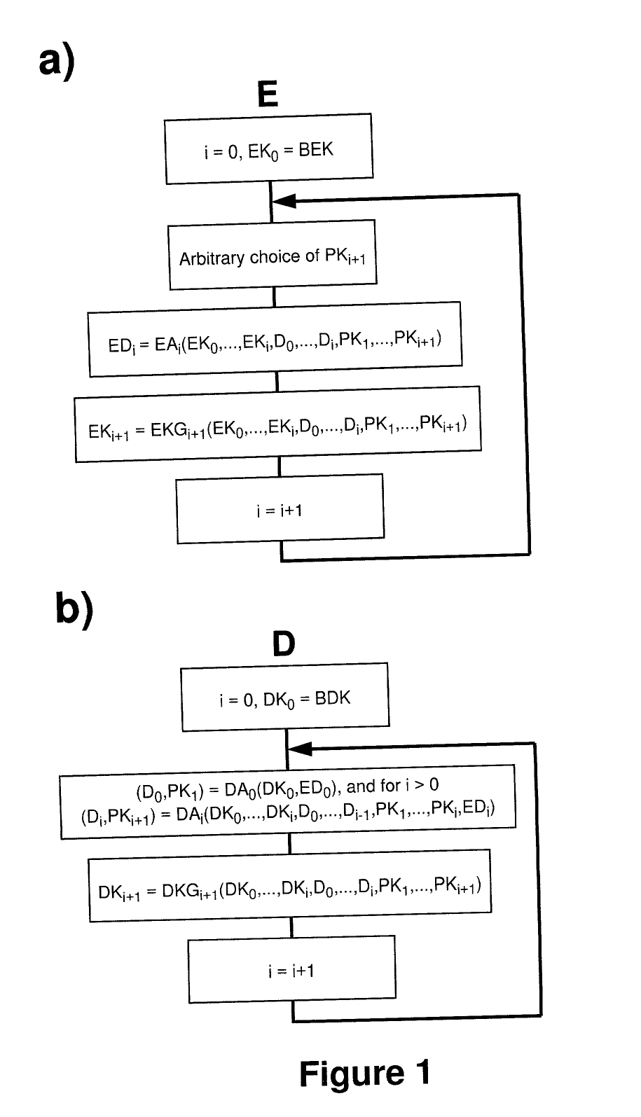

FIG. 1 illustrates the general sequence of steps required by an encryption method according to claims 1, 2 or 5 a) on the side of the encryptor and b) on the side of the decryptor. Upon initialization both, the encryptor and the decryptor, set i=0 and use the basic encryption key BEK as encryption key EK₀=BEK resp. the basic decryption key BDK as decryption key DK₀=BDK for the first iteration.

At the start of the i^{th} iteration the encryptor chooses an arbitrary partial key PKᵢ₊₁. Then he calculates the encrypted data EDᵢ using an arbitrarily selectable encryption algorithm EAᵢ in dependence of the already known encryption keys EK₀=BEK, EK₁, . . . , EKᵢ, original data D₀, . . . , Dᵢ, and partial keys PK₀, . . . , PKᵢ₊₁ according to

EDᵢ=EAᵢ(EK₀, . . . ,EKᵢ,D₀, . . . ,Dᵢ,PK₁, . . . ,PKᵢ₊₁,) (1)

and determines encryption key EKᵢ₊₁ for the next iteration

EKᵢ₊₁=EKGᵢ₊₁(EK₀, . . . ,EK₁,D₀, . . . , Dᵢ, PK₁, . . . ,PKᵢ₊₁), (2)

where for the first iteration (i=0) the following formulas are used:

ED₀=EA₀(EK₀,D₀,PK₁) (3)

EK₁=EKG₁(EK₀,D₀,PK₁). (4)

The decryptor decrypts the encrypted data EDᵢ using decryption algorithm DAᵢ corresponding to encryption algorithm EAᵢ in dependence of decryption keys DK₀, . . . , DKᵢ, already decrypted original data D₀, . . . , Dᵢ₋₁, and partial keys PK₀, . . . , PKᵢ to obtain original data Dᵢ and partial key PKᵢ₊₁ according to

(Dᵢ,PKᵢ₊₁)=DAᵢ(DK₀, . . ,DKᵢ,D₀, . . . ,Dᵢ₋₁,PK₁, . . . ,PKᵢ,EDᵢ) (5)

and determines decryption key DKᵢ₊₁ for the next iteration

DKᵢ₊₁=DKGᵢ₊₁(DK₀, . . . ,DKᵢ,D₀, . . . ,Dᵢ,PK₁, . . . ,PKᵢ₊₁), (6)

where for the first iteration (i=0) the following formulas are used:

(D₀,PK₁)=DA₀(DK₀,ED₀) (7)

DK₁=DKG₁(DK₀,D₀,PK₁). (8)

After encryption resp. decryption of the i^{th} data block encryptor and decryptor set i to i+1 and repeat the same procedure for the following data block. If the original data could be divided into a known number n of data blocks, the process continues until the last data block (n−1) has been encrypted resp. decrypted. In case of a continuous data stream according to claim 2 encryptor and decryptor repeat the iterations endlessly.

The method used in claim 1 and 2 to encrypt original data, which can be divided into a known or unknown number of data blocks, can be applied to the communication between 2 or more communication partners. In this case each individual message can be divided into multiple data blocks and encrypted according to claim 1, or a full message can be treated as a single data block to be encrypted at once (claims 3 and 4). It is of particular importance that each encyptor of the communication partners knows the same basic encryption key BEK and that each decryptor of the communication partners knows at least one basic decryption key BDK corresponding to said basic encryption key BEK and that each communication partner receives all encrypted messages in the same order as they were encrypted. The number of communication partners is not limited and can be chosen arbitrarily. In addition, any communication partner can encrypt the i^{th} message as long as it is guaranteed that each partner knows and/or receives the complete encrypted message stream in the correct order. For example a stream of messages can be encrypted by a single sender or individual messages can be encrypted by different senders and transmitted to all other partners, as long as all participants have access to the complete message stream.

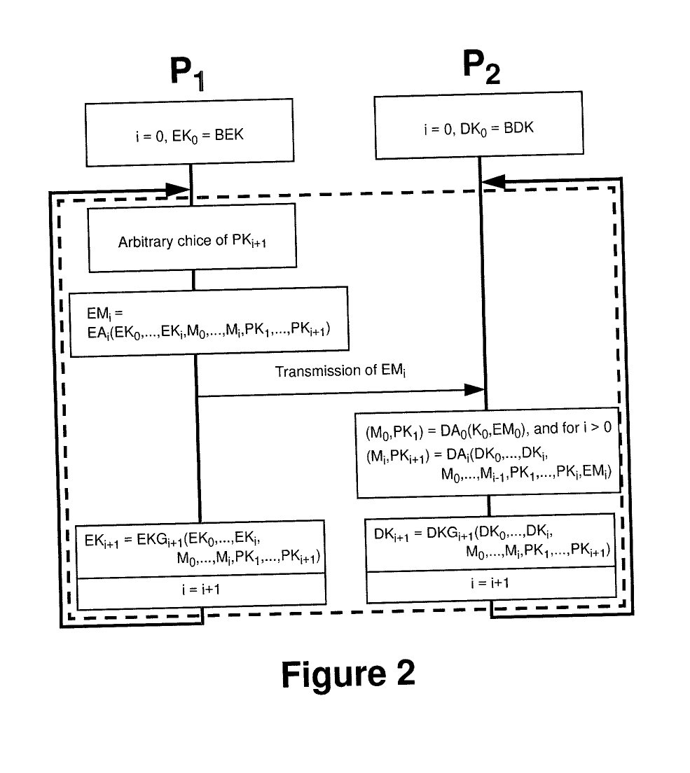

FIG. 2 illustrates the encryption of a message sequence between a sender P₁ and a receiver P₂ with transmission of a single encrypted message EMᵢ during each iteration. Initially sender and receiver set i=0. The sender uses the basic encryption key BEK as first encryption key EK₀=BEK and the receiver the basic decryption key BDK as first decrpytion key DK₀.

At the start of the i^{th} iteration the encryptor chooses an arbitrary partial key PKᵢ₊₁. Then he calculates the encrypted data EMᵢ using an arbitrarily selectable encryption algorithm EAᵢ in dependence of the already known encryption keys EK₀=BEK, EK₁, . . . , EKᵢ, original messages M₀, . . . , Mᵢ, and partial keys PK₀, . . . , PKᵢ₊₁ according to

EMᵢ=EAᵢ(EK₀, . . . ,EKᵢ,M₀, . . . ,Mᵢ,PK₁, . . . ,PKᵢ₊₁) (9)

and determines encryption key EKᵢ₊₁ for the next iteration

EKᵢ₊₁=EKGᵢ₊₁(EK₀, . . . ,EKᵢ,M₀, . . . ,Mᵢ,PK₁, . . . ,PKᵢ₊₁), (10)

where for the first iteration (i=0) the following formulas are used:

EM₀=EA₀(EK₀,M₀,PK₁) (11)

EK₁=EKG₁(EK₀,M₀,PK₁). (12)

P₂ receives encrypted message EMᵢ from P₁ and decrypts EMᵢ using decryption algorithm DAᵢ corresponding to encryption algorithm EAᵢ in dependence of already known decryption keys DK₀, . . . , DKᵢ, already decrypted original messages M₀, . . . , Mᵢ₋₁, and partial keys PK₀, . . . , PKᵢ to obtain the original message Mᵢ and partial key PKᵢ₊₁ according to

(Mᵢ,PKᵢ₊₁)=DAᵢ(DK₀, . . . ,DKᵢ,M₀, . . . ,Mᵢ₋₁,PK₁, . . . ,PKᵢ,EMᵢ) (13)

and determines decryption key DKᵢ₊₁ for the next iteration

DKᵢ₊₁=DKGᵢ₊₁(DK₀, . . . ,DKᵢ,M₀, . . . , Mᵢ,PK₁, . . . ,PKᵢ₊₁), (14)

where for the first iteration (i=0) the following formulas are used:

(M₀,PK₁)=DA₀(DK₀EM₀) (15)

DK₁=DKG₁(DK₀,M₀,PK₁). (16)

After encryption resp. decryption of the i^{th} message sender and receiver set i to i+1 and repeat the same procedure for the following message. If a known number n of messages are to be transmitted, the process continues until the last message (n−1) has been encrypted resp. decrypted. In case of a continuous message stream according to claim 4 sender and receiver repeat the iterations endlessly.

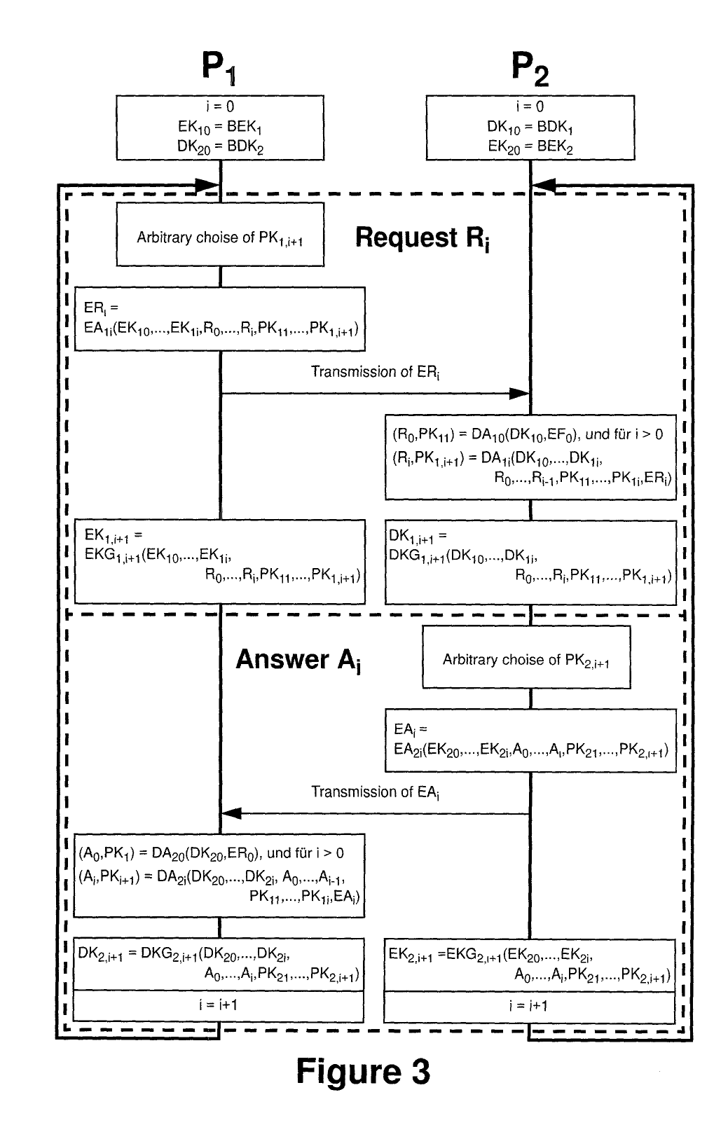

FIG. 3 illustrates an example of an encryption method according to claims 3 or 4 using different basic encryption and decryption keys and different encryption and decryption key generators (i.e. an asymmetric encryption method). In contrast to the example shown in FIG. 2 P₁ and P₂ alternate in this example as encryptor/sender and decryptor/receiver. This scheme is particularity appropriate for transaction oriented client/server systems, in which a client (P₁) sends an request Rᵢ to the server (P₂) and the server replies to the client with answer Aᵢ, whereupon the client continues with the next request Rᵢ₊₁. The client P₁ encrypts his requests using the basic encryption key BEK₁ and the generated encryption keys EK₁ᵢ. The server P₂ decrypts the encrypted requests ERᵢ using the basic decryption key BDK₁ and the generated decryption keys DK₁ᵢ. In this example the server P₂ uses a second encryption thread, completely independent of the encryption of the clients requests, to encrypt the sequence of answers Aᵢ. This second encryption thread is based upon the basic encryption key BEK₂ and the generated encryption keys EK₂ᵢ. The client P₁ on his turn decrypts the server's answers Aᵢ using the basic decryption key BDK₂ and the generated decryption keys DK₂ᵢ.

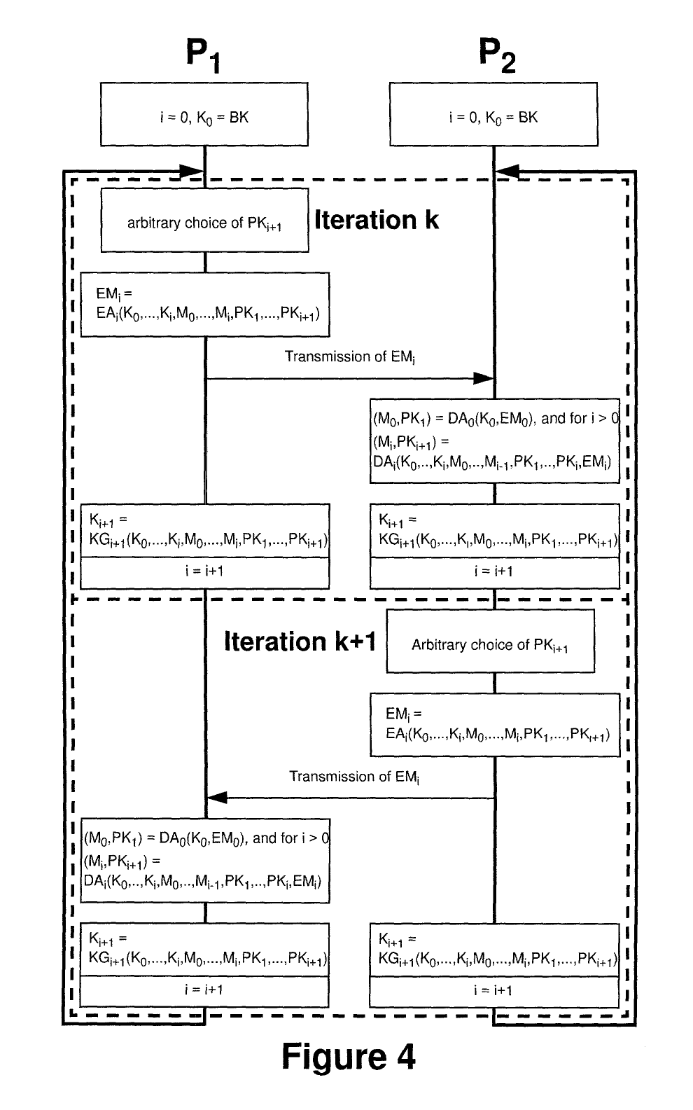

FIG. 4 illustrates another example of an encryption method according to claims 3 or 4, where for each i>=0 the encryption key EKᵢ is identical to the decryption key DKᵢ (i.e. a symmetric encryption method). In contrast to the example given in FIG. 2 in this example P₁ and P₂ alternate in iteration k and k+1 as sender resp. receiver. This variant is also especially well suited for transaction oriented clien/server systems, in which a client (P₁) sends in iteration k a request Rᵢto a server (P₂) and the server replies in iteration k+1 to the client with answer Aᵢ, after which the client continues with the following request Rᵢ₊₁.

The choice of encryption algorithms EAᵢ is arbitrary to the extent, that for each encryption algorithm EAᵢ a corresponding decryption algorithm DAᵢ must exist, with which the decryptor is able to decrypt the encrypted data/message ED/Mᵢ, knowing the previous decryption keys DK₀, . . . , DKᵢ, the already decrypted data/messages D/M₀, . . . , D/Mᵢ₋₁ and partial key PK₁, . . . , PKᵢ, and thus is able to determine the original data/message D/Mᵢ and partial key PKᵢ₊₁.

The encryption and decryption algorithms EAᵢ and DAᵢ can use either all specified parameters explicitly or use only an arbitrary subset of the specified parameters explicitly and be independent of all specified parameters not included in the particular subset.

To reduce the necessary calculation time the following special cases are especially advantageous:

The encryption algorithms EAᵢ depend only on the last encryption key EKᵢ, the last chosen partial key PKᵢ₊₁ and the original data/messageD/Mᵢ

EDᵢ=EAᵢ(EKᵢ,Dᵢ,PKᵢ₊₁) resp. EMᵢ=EAᵢ(EKᵢ,Mᵢ,PKᵢ₊₁). (17)

Encryption key generator EKGᵢ₊₁ only depends on the last chosen partial key PKᵢ₊₁

EKᵢ₊₁=EKGᵢ₊₁(PKᵢ₊₁), (18)

with the trivial example EKᵢ₊₁=PKᵢ₊₁. In this case an attacker can actually, after decryption of the i^{th} data/message ED/Mᵢ, decrypt the i+1^{st} data/message ED/Mᵢ₊₁ and therefore all following encrypted data resp. messages. Such a system only offers perfect backward security and no forward security.

This disadvantage can be fixed by an additional dependence of enryption key generator EKGᵢ₊₁ on the basic encryption key EK₀=BEK:

EKᵢ₊₁=EKGᵢ₊₁(EK₀,PKᵢ₊₁), (19)

DKᵢ₊₁=DKGᵢ₊₁(DK₀,PKᵢ₊₁). (20)

An attacker able to decrypt the i^{th} data/message ED/Mᵢ reveals the i^{th} decryption key DKᵢ as well as the i+1^{st} partial key PKᵢ₊₁. Nevertheless, this knowledge alone is neither sufficient to determine the i+1^{st} decryption key DKᵢ₊₁ nor to decrypt the i+1^{st} data/message ED/Mᵢ₊₁, because it requires the additional knowledge of basic decryption key DK₀=BDK. But the attacker could after decryption of several encrypted data/messages potentially guess the secret key using statistical methods.

The basic encryption key BEK and/or basic decryption key BDK can be further protected against statistical analysis of the final encryption keys EKᵢ and/or decryption keys DKᵢ by an additional dependence of encryption key generators EKGᵢ₊₁ on all previous used encryption keys EK₀, . . . , EKᵢ

EKᵢ₊₁=EKGᵢ₊₁(EK₀, . . . ,EKᵢ,PKᵢ₊₁) (21)

and of decryption key generators DKGᵢ₊₁ on all previous used decryption keys DK₀, . . . , DKᵢ

DKᵢ₊₁=DKGᵢ₊₁(DK₀, . . . ,DKᵢ,PKᵢ₊₁) (22)

or with an additional dependence on original data/messages D/M₀, . . . , D/Mᵢ

EKᵢ₊₁=EKGᵢ₊₁(EK₀, . . . ,EKᵢ,D/M₀, . . . ,D/Mᵢ,PKᵢ₊₁) (23)

DKᵢ₊₁=DKGᵢ₊₁(DK₀, . . . ,DKᵢ,D/M₀, . . . ,D/Mᵢ,PKᵢ₊₁) (24)

or with an additional dependence on the previous partial key PK₁, . . . , PKᵢ

EKᵢ₊₁=EKG_{i +1}(EK₀, . . . ,EKᵢ,D/M₀, . . . ,D/Mᵢ,PK₁, . . . ,PKᵢ,PKᵢ₊₁). (25)

DKᵢ₊₁=DKGᵢ₊₁(DK₀, . . . ,DKᵢ,D/M₀, . . . ,D/Mᵢ,PK₁, . . . ,PKᵢ,PKᵢ₊₁). (26)

In all of these cases the attacker requires the knowledge of the complete encryption history, to determine from a single decrypted data block/message ED/Mᵢ the decryption key for the following data/message DKᵢ₊₁. Choosing absolute random numbers as partial key PKᵢ₊₁ significantly hardens the encryption method against statistical analysis of the final encryption/decryption keys to determine the basic encryption and/or decryption key. Because of the increasing dependence on the absolutely randomly selectable partial keys PKthe distribution of the final encryption and decryption keys converges with increasing number of iterations towards a uniform distribution containing less and less exploitable statistical information.

The weakest point of the presented encryption methods is indeed the very first message encrypted with the plain basic encryption key BEK=EK₀. This point can be fortified by using a particularly strong encryption algorithm EA₀ and/or a particularly long basic encryption key BEK=EK₀. In addition, the system could be initially trained in a protected environment by exchanging a fixed number of encrypted data blocks/messages via a separate communication channel—like a special network path, via telephone, in writing, per firmware or per separate storage media-, which is—with very high probability—inaccessible to potential attackers. Already encryption key EK₁=EKG₁(EK₀, PK₁) resp. decryption key DK₁=DKG₁(DK₀, PK₁) of the second encrypted data/message ED/M₁ contains with PK₁ the first random component. With each iteration the weight of the random components in the final encryption/decryption keys increases by the next partial key PKᵢ.

An attacker decrypting the i^{th} data/message ED/Mᵢ still reveals the i^{th} decryption key DKᵢ as well as the i+1^{st} partial key PKᵢ₊₁. Nevertheless, this knowledge alone is neither sufficient to determine the i+1^{st} decryption key DKᵢ₊₁ nor to decrypt the i+1st data/message ED/Mᵢ₊₁, because it requires the additional knowledge of the basic decryption key DK₀ and the complete history of previous decryption keys DK₀, . . . , DKᵢ, the previous original data/messages D/M₀, . . . , D/Mᵢ and/or previous partial key PK₁, . . . , PKᵢ.

A concrete example of an encryption method according to one of the claims 1 and 2 assumes, that the secret basic encryption and decryption keys are identical (i.e. EK₀=DK₀=BEK=BDK=BK), have a fix length of 256 bits and are initially already known to the encryptor and decryptor or exchanged via a known key exchange method according to Diffie-Hellmann (U.S. Pat. No. 4,200,770) or IKE (Internet RCF 2409, “IPSec”, 2000, Addison-Wesley, p. 117ff)-. The original data is grouped into data blocks of the same length as the secret key (256 Bits), if necessary, filling the last data block to the required length with arbitrary data. All partial keys PKᵢ have also the same length as the secret key (256 Bits). In each iteration a new partial key PKᵢ is generated with a (pseudo) random number generator and attached to the original data Dᵢ to form a 512-bit data block DᵢPKᵢ₊₁, the data block DᵢPKᵢ₊₁—consisting of the two partial blocks Dᵢ and PKᵢ₊₁—is encrypted with key Kᵢ=EKᵢ=DKᵢ using an arbitrary encryption algorithm EA.

EDᵢ=EAᵢ(Kᵢ,DᵢPKᵢ₊₁)=EA(Kᵢ,DᵢPKᵢ₊₁), (27)

and finally the new key Kᵢ₊₁ for the following iteration is determined according to

Kᵢ₊₁=K₀xor(Dᵢxor PKᵢ₊₁), (28)

where for the first iteration (i=0) the following formulas are used

ED₀=EA₀(K₀,D₀PK₁)=EA(K₀,D₀PK₁) (29)

K₁=K₀xor(D₀xor PK₁) (30)

and “xor” denotes the bitwise boolean “exclusive or” -function.

In the i^{th} iteration the decryptor decrypts encrypted data EDᵢ using decryption algorithm DA corresponding to encryption algorithm EA in dependence of previous key Kᵢ to determine the data block DᵢPKᵢ₊₁, original data Dᵢ and partial key PKᵢ₊₁

(Dᵢ,PKᵢ₊₁)=DᵢPKᵢ₊₁=DAᵢ(Kᵢ,EDᵢ)=DA(Kᵢ,EDᵢ) (31)

and calculates key Kᵢ₊₁ for the next iteration

Kᵢ₊₁=K₀xor(Dᵢxor PKᵢ₊₁), (32)

where for the first iteration (i=0) the following formulas are used

(D₀,PK₁)=D₀PK₁=DA(K₀,ED₀) (33)

K₁=K₀xor(D₀xor PK₁). (34)

This example can be easily modified, such that key Kᵢ depends on all previous partial key PK₁, . . . , PKᵢ by calculating in each iteration with i>0 an additional cumulative partial key KPKᵢ₊₁

KPKᵢ₊₁=KPKᵢxor PKᵢ₊₁ with KPK₁=PK₁ (35)

and using KPKᵢ₊₁ instead of PKᵢ₊₁ as argument for the key generator

Kᵢ₊₁=K₀xor(Dᵢxor KPKᵢ₊₁). (36)

The same procedure can also be applied to the original data Dᵢ, by calculating in each iteration with i>0 the cumulative data KDᵢ₊₁

KDᵢ₊₁=KDᵢxor Dᵢ with KD₁=D₀ (37)

and using KDᵢ₊₁ instead of Dᵢ₊₁ as argument for the key generator

Kᵢ₊₁=K₀xor(KDᵢxor KPKᵢ₊₁). (38)

An encryption method according to claims 1 or 2 is not limited to a fixed block length of neither the original data nor the keys nor the partial keys. These block lengths are all completely independent from each other and can be arbitrarily chosen, even varied from iteration to iteration, as long as the respective encryption and decryption algorithms are able to process them.

The same example can be easily applied to a message oriented encryption method according to claims 3 or 4, where the individual messages are taken as individual encryption units (data blocks) or divided into several separately encrypted data blocks.

The encryption methods described in this patent are not limited to programmable computers only. Instead they can also be applied in the firmware of any kind of machine or executed completely or partially by humans.

The arbitrary choice of

1. the encryption algorithms and key generators and

2. the parameters explicitly used in the encryption algorithms and key generators allows to derive directly or indirectly a whole set of new iterative encryption methods, which all use arbitrarily selectable one-time encryption keys according to the principles of this patent and which all are claimed by this patent.

I claim:

1. Method to encrypt arbitrary data D, which data D can be divided into n (n>=2) data blocks D₀, . . . , Dₙ₋₁, where each data block Dᵢ is of arbitrary size, whereby
i. the encryptor E knows at least one arbitrary secret basic encryption key BEK, which basic encryption key BEK is used in iteration i=0 as encryption key EK₀=BEK, and
ii. the decryptor D knows at least one arbitrary secret basic decryption key BDK corresponding to said basic encryption key BEK, which basic decryption key BDK is used in iteration i=0 as decryption key DK₀=BDK, and
iii. the encryptor E starting at i=0 iteratively for all integer i<n—to encrypt data block Dᵢ
first chooses an arbitrary partial key PKᵢ₊₁,
second calculates the encrypted data block EDᵢ using an arbitrary encryption algorithm EAᵢ in dependence of EK₀, . . . , EKᵢ, D₀, . . . , Dᵢ, and PK₁, . . . , PKᵢ₊₁, i.e.
EDᵢ=EAᵢ(EK₀, . . . ,EKᵢ,D₀, . . . ,Dᵢ,PK₁, . . . ,PKᵢ₊₁), and
third determines the encryption key EKᵢ₊₁ using an arbitrary encryption key generator EKGᵢ₊₁ in dependence of EK₀, . . . , EKᵢ, D₀, . . . ,Dᵢ, and PK₁, . . . ,PKᵢ₊₁, i.e.
EKᵢ₊₁=EKGᵢ₊₁(EK₀, . . . ,EKᵢ,D₀, . . . ,Dᵢ,PK₁, . . . ,PKᵢ₊₁), and
iv. the decryptor D starting at i=0—to decrypt data block ED₀—determines the original data block D₀ and partial key PK₁ using a decryption algorithm DA₀ corresponding to said encryption algorithm EA₀ in dependence of said decryption key DK₀ and said encrypted data block ED₀, i.e.
(D₀,PK₁)=DA₀(DK₀,ED₀), and
starting at i=1 iteratively for all integer i<n—to decrypt data block EDᵢ—determines the original data block Dᵢ and partial key PKᵢ₊₁ using a decryption algorithm DAᵢ corresponding to said encryption algorithm EAᵢ in dependence of DK₀, . . . , DKᵢ, D₀, . . . , Dᵢ₋₁, and PK₁, . . . , PKᵢ, i.e.
(Dᵢ,PKᵢ₊₁)=DAᵢ(DK₀, . . . ,DKᵢ,D₀, . . . ,Dᵢ₋₁,EDᵢ,PK₁, . . . ,PKᵢ), and
for all i iteratively determines key DKᵢ₊₁ using decryption key generator DKGᵢ₊₁ corresponding to said encryption key generator EKGᵢ₊₁ in dependence of DK₀, . . . , DKᵢ, D₀, . . . , Dᵢ, and PK₁, . . . , PKᵢ₊₁, i.e.
DKᵢ₊₁=DKGᵢ₊₁(DK₀, . . . ,DKᵢ,D₀, . . . ,Dᵢ,PK₁, . . . ,PKᵢ₊₁).

2. Method to encrypt a continuous data stream DS of unknown length, which data stream DS can be divided into a sequence of an unknown number of data blocks Dᵢ (i>0), where each data block Dᵢ is of arbitrary size, whereby
i. the encryptor E knows at least one arbitrary secret basic encryption key BEK, which basic encryption key BEK is used in iteration i=0 as encryption key EK₀=BEK, and
ii. the decryptor D knows at least one arbitrary secret basic decryption key BDK corresponding to said basic encryption key BEK, which basic decryption key BDK is used in iteration i=0 as decryption key DK₀=BDK, and
iii. the encryptor E starting at i=0 iteratively for all integer i—to encrypt data block Dᵢ
first chooses an arbitrary partial key PKᵢ₊₁,
second calculates the encrypted data block EDᵢ using an arbitrary encryption algorithm EAᵢ in dependence of EK₀, . . . , EKᵢ, D₀, . . . , Dᵢ, and PK₁, . . . , PKᵢ₊₁, i.e.
EDᵢ=EAᵢ(EK₀, . . . ,EKᵢ,D₀, . . . ,Dᵢ,PK₁, . . . ,PKᵢ₊₁), and
third determines the encryption key EKᵢ₊₁ using an arbitrary encryption key generator EKGᵢ₊₁ in dependence of EK₀, . . . , EKᵢ, D₀, . . . , Dᵢ, and PK₁, . . . , PKᵢ₊₁, i.e.
EKᵢ₊₁=EKGᵢ₊₁(EK₀, . . . ,EKᵢ,D₀, . . . ,Dᵢ,PK₁, . . . ,PKᵢ₊₁), and
iv. the decryptor D starting at i=0—to decrypt data block ED₀—determines the original data block D₀ and partial key PK₁ using a decryption algorithm DA₀ corresponding to said encryption algorithm EA₀ in dependence of said decryption key DK₀ and said encrypted data block ED₀, i.e.
(D₀,PK₁)=DA₀(DK₀,ED₀), and
starting at i=1 iteratively for all integer i—to decrypt data block EDᵢ—determines the original data block Dᵢ and partial key PKᵢ₊₁ using a decryption algorithm DAᵢ corresponding to said encryption algorithm EAᵢ in dependence of DK₀, . . . , DKᵢ, D₀, . . . , Dᵢ₋₁, and PK₁, . . . , PKᵢ, i.e.
(Dᵢ,PKᵢ₊₁)=DAᵢ(DK₀, . . . ,DKᵢ,D₀, . . . ,Dᵢ₋₁,EDᵢ,PK₁, . . . ,PKᵢ), and
for all i iteratively determines decryption key DKᵢ₊₁ using decryption key generator DKGᵢ₊₁ corresponding to said encryption key generator EKGᵢ₊₁ in dependence of DK₀, . . . , DKᵢ, D₀, . . . , Dᵢ, and PK₁, . . . , PKᵢ₊₁, i.e.
DKᵢ₊₁=DKGᵢ₊₁(DK₀, . . . ,DKᵢ,D₀, . . . ,Dᵢ,PK₁, . . . ,PKᵢ₊₁).

3. Method to encrypt a sequence of n messages Mᵢ (0<=i<n), where each message Mᵢ is of arbitrary size, between an arbitrary number p>=2 of communication partners P₁, . . . , Pₚ, whereby
i. each encryptor of the communication partners P₁, . . . , Pₚ knows at least one arbitrary secret basic encryption key BEK, which basic encryption key BEK is used in iteration i=0 as encryption key EK₀=BEK, and
ii. each decryptor of the communication partners P₁, . . . , Pₚ knows at least one arbitrary secret basic decryption key BDK corresponding to said basic encryption key BEK, which basic decryption key BDK is used in iteration i=0 as decryption key DK₀=BDK, and
iii. starting at i=0 iteratively for all integer i with i<n exactly one communication partner Pⱼᵢ(1<=ⱼᵢ<=p)—to encrypt data block Dᵢ
first chooses an arbitrary partial key PKᵢ₊₁,
second calculates the encrypted message EMᵢ using an arbitrary encryption algorithm EAᵢ in dependence of EK₀, . . . , EKᵢ, M₀, . . . , Mᵢ, and PK₁, . . . , PKᵢ₊₁, i.e.
EMᵢ=EAᵢ(EK₀, . . . ,EKᵢ,M₀, . . . ,Mᵢ,PK₁, . . . ,PKᵢ₊₁), and
third determines the encryption key EKᵢ₊₁ using an arbitrary encryption key generator EKGᵢ₊₁ in dependence of EK₀, . . . , EKᵢ, M₀, . . . , Mᵢ, and PK₁, . . . , PKᵢ₊₁, i.e.
EKᵢ₊₁=EKGᵢ₊₁(EK₀, . . . ,EKᵢ,M₀, . . . ,Mᵢ,PK₁, . . . ,PKᵢ₊₁), and
fourth transmits the encrypted message EMᵢ to all communication partners P₁, . . . , Pₚ except Pⱼᵢ, and
iv. starting at i=0 iteratively for all integer i all communication partners P₁, . . . , Pₚ except Pⱼᵢ receive the encrypted message EMᵢ from Pⱼᵢ, and
to decrypt data block EM₀—determine the original message M₀ and partial key PK₁ using a decryption algorithm DA₀ corresponding to said encryption algorithm EA₀ in dependence of said decryption key DK₀ and said encrypted message EM₀, i.e.
(M₀,PK₁)=DA₀(DK₀,EM₀), and
to decrypt message EMᵢ(i>0)—determine the original message Mᵢ and partial key PKᵢ₊₁ using a decryption algorithm DAᵢ corresponding to said encryption algorithm EAᵢ in dependence of DK₀, . . . , DKᵢ, D₀, . . . , Dᵢ₋₁, and PK₁, . . . , PKᵢ, i.e.
(Mᵢ,PKᵢ₊₁)=DAᵢ(DK₀, . . . ,DKᵢ,M₀, . . . ,Mᵢ₋₁,EMᵢ,PK₁, . . . ,PKᵢ), and
for all i iteratively determine decryption key DKᵢ₊₁ using decryption key generator DKGᵢ₊₁ corresponding to said encryption key generator EKGᵢ₊₁ in dependence of DK₀, . . . , DKᵢ, M₀, . . . , Mᵢ, and PK₁, . . . , PKᵢ₊₁, i.e.
DKᵢ₊₁=DKGᵢ₊₁(DK₀, . . . ,DKᵢ,M₀, . . . . ,M₁,PK₁, . . . ,PKᵢ₊₁).

4. Method to encrypt a sequence of an unknown number of messages Mᵢ(0<=i), where each message Mᵢ is of arbitrary size, between an arbitrary number p>=2 of communication partners P₁, . . . , Pₚ, whereby
i. each encryptor of the communication partners P₁, . . . , Pₚ knows at least one arbitrary secret basic encryption key BEK, which basic encryption key BEK is used in iteration i=0 as encryption key EK₀=BEK, and
ii. each decryptor of the communication partners P₁, . . . , Pₚ knows at least one arbitrary secret basic decryption key BDK corresponding to said basic encryption key BEK, which basic decryption key BDK is used in iteration i=0 as decryption key DK₀=BDK, and
iii. starting at i=0 iteratively for all integer i exactly one communication partner Pⱼᵢ(1<=ji<=p)—to encrypt data block Dᵢ
first chooses an arbitrary partial key PKᵢ₊₁,
second calculates the encrypted message EMᵢ using an arbitrary encryption algorithm EAᵢ in dependence of EK₀, . . . , EKᵢ, M₀, . . . , Mᵢ, and PK₁, . . . , PKᵢ₊₁, i.e.
EMᵢ=EAᵢ(EK₀, . . . ,EKᵢ,M₀, . . . ,Mᵢ,PK₁, . . . ,PKᵢ₊₁), and
third determines encryption key EKᵢ₊₁ using an arbitrary encryption key generator EKGᵢ₊₁ in dependence of EK₀, . . . , EKᵢ, M₀, . . . , Mᵢ, and PK₁, . . . , PKᵢ₊₁, i.e.
EKᵢ₊₁=EKGᵢ₊₁(EK₀, . . . ,EKᵢ,M₀, . . . ,Mᵢ,PK₁, . . . ,PKᵢ₊₁), and
fourth transmits the encrypted message EMᵢ to all communication partners P₁, . . . , Pₚ except Pⱼᵢ, and
iv. starting at i=0 iteratively for all integer i all communication partners P₁, . . . , Pₚ except Pⱼᵢ receive the encrypted message EMᵢ from Pⱼᵢ, and
to decrypt data block EM₀—determine the original message M₀ and partial key PK₁ using a decryption algorithm DA₀ corresponding to said encryption algorithm EA₀ in dependence of said decryption key DK₀ and said encrypted message EM₀, i.e.
(M₀,PK₁)=DA₀(DK₀,EM₀), and
to decrypt message EMᵢ(i>0)—determine the original message Mᵢ and partial key PKᵢ₊₁ using a decryption algorithm DAᵢ corresponding to said encryption algorithm EAᵢ in dependence of DK₀, . . . , DKᵢ, D₀, . . . , Dᵢ₋₁, and PK₁, . . . , PKᵢ, i.e.
(Mᵢ,PKᵢ₊₁)=DAᵢ(DK₀, . . . ,DKᵢ,M₀, . . . ,Mᵢ₋₁,EMᵢ,PK₁, . . . ,PKᵢ), and
for all i iteratively determine decryption key DKᵢ₊₁ using decryption key generator DKGᵢ₊₁ corresponding to said encryption key generator EKGᵢ₊₁ in dependence of DK₀, . . . , DKᵢ, M₀, . . . , Mᵢ, and PK₁, . . . , PKᵢ₊₁, i.e.
DKᵢ₊₁=DKGᵢ₊₁(DK₀, . . . ,DKᵢ,M₀, . . . ,Mᵢ,PK₁, . . . ,PKᵢ₊₁).

5. Encryption method according to one of the claims 1 or 3, whereby—during the last iteration i=n−1—the encryptor does not determine encyption key EKₙ and/or at least one decryptor does not determine decyption key DKₙ.

6. Encryption method according to one of the previous claims, whereby at least one basic encryption key BEK or at least basic decryption key BDK is initially exchanged between the encryptor and the decryptor(s) resp. message recipient(s) using a state of the art key exchange method.

7. Encryption method according to one of the previous claims, whereby the encryption only starts if at least one encryptor has proven the knowledge of the at least one basic encryption key BEK using a state of the art knowledge proof method.

8. Encryption method according to claim 7, whereby the knowledge proof does not require the explicit transmission of the basic encryption key BEK between the communication partners.

9. Encryption method according to one of the previous claims, whereby the encryption only starts if at least one decryptor has proven the knowledge of the at least one basic decryption key BDK corresponding to said basic encryption key BEK using a state of the art knowledge proof method.

10. Encryption method according to claim 9, whereby the knowledge proof does not require the explicit transmission of the basic decryption key BDK between the communication partners.

11. Encryption method according to one of the previous claims, whereby at least one of the partial keys PKᵢ (i>0) is chosen by a pseudo random number generator.

12. Encryption method according to one of the previous claims, whereby at least one of the partial keys PKᵢ (i>0) is chosen by an absolute random number generator.

13. Encryption method according to one of the previous claims, whereby the basic encryption key BEK is identical to the basic decryption key BDK.

14. Encryption method according to one of the previous claims, whereby in at least one iteration i the encryption key generator EKGᵢ is identical to the decryption key generator DGKᵢ.

15. Encryption method according to one of the previous claims, whereby the same encryption and decryption algorithms are used in at least two iterations.

16. Encryption method according to one of the previous claims, whereby for at least one i>=0 the encryptor resp. the sending communication partner chooses the encryption algorithm EAᵢ out of a given set SEAᵢ of different encryption algorithms in dependence of the already transmitted and therefore known encryption keys EK₀, . . . , EKᵢ, data D₀, . . . , Dᵢ₋₁, partial keys PK₁, . . . , PKᵢ or the encrypted data EDᵢ resp. the encrypted message EMᵢ, and the decryptor resp. receiving communication partner is able to determine decryption algorithm DAᵢ corresponding to said encryption algorithm EAᵢ implicitly in dependence of the decryption keys DK₀, . . . , DKᵢ, data or messages D₀/M₀, . . . , Dᵢ₋₁/Mᵢ₋₁, partial keys PK₁, . . . , PKᵢ or the encrypted data EDᵢ resp. message EMᵢ out of a set of decryption algorithms SDAᵢ corresponding to said set SEAᵢ of encryption algorithms.

17. Encryption method according to claim 16, whereby in at least two iterations—i1 and i2—the set of encryption algorithms SEAᵢ₁ is identical to the set of encryption algorithms SEAᵢ₂.

18. Encryption method according to one of the previous claims, whereby for at least one i>0 encryption key EKᵢ can be determined using an arbitrary encryption key generator EKGᵢ in dependence of encryption keys EK₀ and EKᵢ₋₁ as well as in dependence of partial key PKᵢ, i.e. EKᵢ=EKGᵢ(EK₀, EKᵢ₋₁, PKᵢ).

19. Encryption method according to claim 18, whereby in at least two iterations i and j the same encryption key generator EKGᵢ=EKGⱼ is used.

20. Encryption method according to one of the previous claims, whereby for at least one i>=0 the encryptor resp. the sending communication partner chooses the encryption key generator EKGᵢ₊₁ out of a given set SEKGᵢ of different encryption key generators in dependence of encryption keys EK₀, . . . , EKᵢ, data or messages D₀/M₀, . . . , Dᵢ/Mᵢ, partial keys PK₁, . . . , PKᵢ₊₁ or the encrypted data EDᵢ resp. the encrypted message EMᵢ, and the decryptor resp. receiver is able to determine the decryption key generator DKGᵢ corresponding to said encryption key generator EKGᵢ₊₁ implicitly in dependence of decryption keys DK₀, . . . , DKᵢ, data or messages D₀/M₀, . . . , Dᵢ/Mᵢ, partial keys PK₁, . . . , PKᵢ₊₁ or encrypted data EDᵢ resp. message EMᵢ out of set SDKGᵢ of decryption key generators corresponding to said set SEKGᵢ of encryption key generators.

21. Encryption method according to one of the previous claims, whereby for at least one i>0 original data Dᵢ resp. message Mᵢ is extended before encryption by arbitrarily selectable data ZD and said data ZD is removed after decryption.

22. Encryption method according to claim 21, whereby said additional data ZD is generated by a pseudo random number generator.

23. Encryption method according to claim 21, whereby said additional data ZD is generated by an absolute random number generator.
